(19) United States
(12) Patent Application Publication
(10) Pub. No.: US 2010/0060874 A1
(43) Pub. Date: Mar. 11, 2010

(54) Maskless lithographic apparatus and methods of compensation for rotational alignment error using the same

(75) Inventors: Jeongmin Kim, Suwon-si (KR); Sangwoo Bae, Seoul (KR); Hikuk Lee, Youngin-si (KR); Sangdon Jang, Ansan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/461,798

(22) Filed: Aug. 25, 2009

(30) Foreign Application Priority Data
Sep. 11, 2008 (KR) 10-2008-0090013

(51) Int. Cl. G03B 27/54

(52) U.S. Cl. 355/67

(57) ABSTRACT

A maskless lithographic apparatus may include a light source providing an exposure beam, a light modulator modulating the exposure beam according to an exposure pattern, an exposure optical system delivering the modulated exposure beam provided by the light modulator onto a substrate in a form of a beam spot array, and a control unit switching off some rows in the beam spot array in order to make exposure energy distribution uniform across the beam spot array. A method for compensating for an alignment error using a maskless lithographic apparatus may include providing an exposure beam, modulating the exposure beam according to an exposure pattern, delivering the modulated exposure beam provided by a light modulator onto a substrate in a form of a beam spot array, and switching off some rows in the beam spot array in order to make exposure energy distribution uniform across the beam spot array.

### PRIORITY STATEMENT

This application claims priority from Korean Patent Application No. 10-2008-0090013, filed on Sep. 11, 2008, in the Korean Intellectual Property Office (KIPO), the entire contents of which are incorporated herein by reference.

### BACKGROUND

1. Field

Example embodiments relate to lithographic apparatuses and methods of compensating for rotational alignment error using the same. Also, example embodiments relate to maskless lithographic apparatuses and methods for compensating for rotational alignment error using the same.

2. Description of Related Art

Lithography is typically the transfer of a geometric shape (i.e., pattern) on a mask to a thin photosensitive material (photoresist) coated on a surface of a substrate by exposure to light. A lithographic apparatus engraves an actually designed pattern coated with a photosensitive material using a light source. The lithographic apparatus typically includes a mask (or reticle) that is an original plate with a designed pattern drawn thereon, an alignment device precisely aligning a mask with a substrate, and a light source emitting light with a wavelength that induces a photochemical reaction to a photosensitive material.

A display industry is usually called “equipment industry” because devices in the industry occupy a large percentage from cost and technical perspectives. As a display screen area has recently increased, the dimension of a lithographic mask is increasing. However, increasing a mask size not only poses significant technical limitations but also results in exponential increase in manufacturing cost. In order to overcome the drawbacks, a maskless lithographic apparatus has emerged as a promising device that may increase a display panel area and/or eliminate the manufacturing cost of a mask.

### SUMMARY

Example embodiments may provide a maskless lithographic apparatus that may engrave a photosensitive layer on a substrate to form a desired pattern without the need for a mask or reticle and also may compensate for non-uniformity of exposure amount due to a rotational alignment error in an exposure head.

Example embodiments also may provide a method for compensating for unevenness in exposure amount due to a rotational alignment error of an exposure head in a maskless lithographic apparatus.

According to example embodiments, a maskless lithographic apparatus may include a light source providing an exposure beam, a light modulator modulating the exposure beam according to an exposure pattern, an exposure optical system delivering the modulated exposure beam provided by the light modulator onto a substrate in a form of a beam spot array, and a control unit switching off some rows in the beam spot array in order to make exposure energy distribution uniform across the beam spot array.

According to example embodiments, a method for compensating for alignment error using a maskless lithographic apparatus may include providing an exposure beam, modulating the exposure beam according to an exposure pattern, delivering the modulated exposure beam provided by a light modulator onto a substrate in a form of a beam spot array, and switching off some rows in the beam spot array in order to make exposure energy distribution uniform across the beam spot array.

### BRIEF DESCRIPTION OF THE DRAWINGS

The above and/or other aspects and advantages will become more apparent and more readily appreciated from the following detailed description of example embodiments taken in conjunction with the accompanying drawings, in which:

FIG. 1 is a conceptual diagram of a maskless lithographic apparatus according to example embodiments;

FIG. 2 is a cross-sectional view of the maskless lithographic apparatus of FIG. 1;

FIG. 3 is a plan view of a beam spot array in the maskless lithographic apparatus of FIG. 1;

FIG. 4 is a flowchart illustrating a method of compensating for an alignment error in a maskless lithographic apparatus according to example embodiments;

FIGS. 5A through 5D are plan views illustrating rows of micromirrors in a light modulator and/or micro lenses in a micro-lens array that are switched off according to example embodiments;

FIGS. 6A through 6C are plan views illustrating distribution of exposure energy that varies with an alignment error in a maskless lithographic apparatus according to example embodiments;

FIG. 7A illustrates exposure energy distribution and aerial images produced without compensation for an alignment error;

FIG. 7B illustrates exposure energy distribution and aerial images produced with compensation for an alignment error;

FIG. 8A illustrates an aerial image of an exposure pattern produced without compensation for an alignment error;

FIG. 8B illustrates an aerial image of an exposure pattern produced with compensation for an alignment error;

FIG. 9A is a graph of an actual iteration number K and an integerized iteration number m against an alignment angle;

FIG. 9B is a graph of the number N′ of rows of a light modulator against an alignment angle (θ) when an alignment error is compensated for; and

FIG. 10 is a graph of the number of rows in a light modulator against an alignment angle for each iteration number m.

### DETAILED DESCRIPTION OF EXAMPLE EMBODIMENTS

Example embodiments will now be described more fully with reference to the accompanying drawings. Embodiments, however, may be embodied in many different forms and should not be construed as being limited to example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when a component is referred to as being “on,” “connected to,” “electrically connected to,” or “coupled to” another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments that may be illustrated in the accompanying drawings, wherein like reference numerals may refer to the like components throughout.

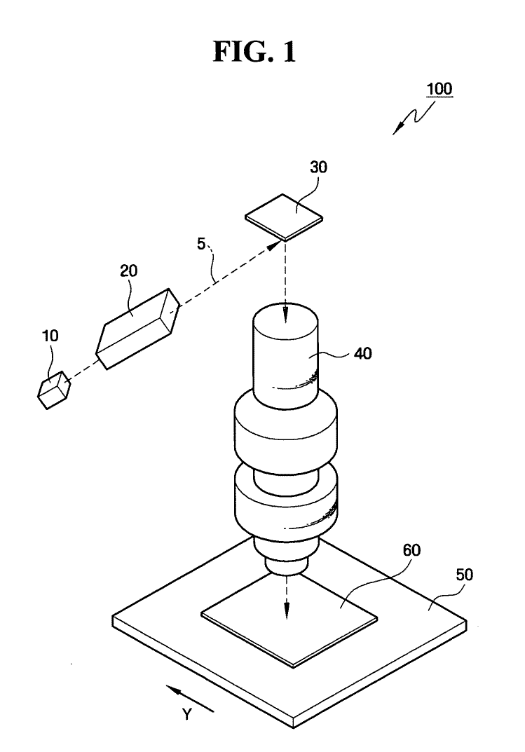

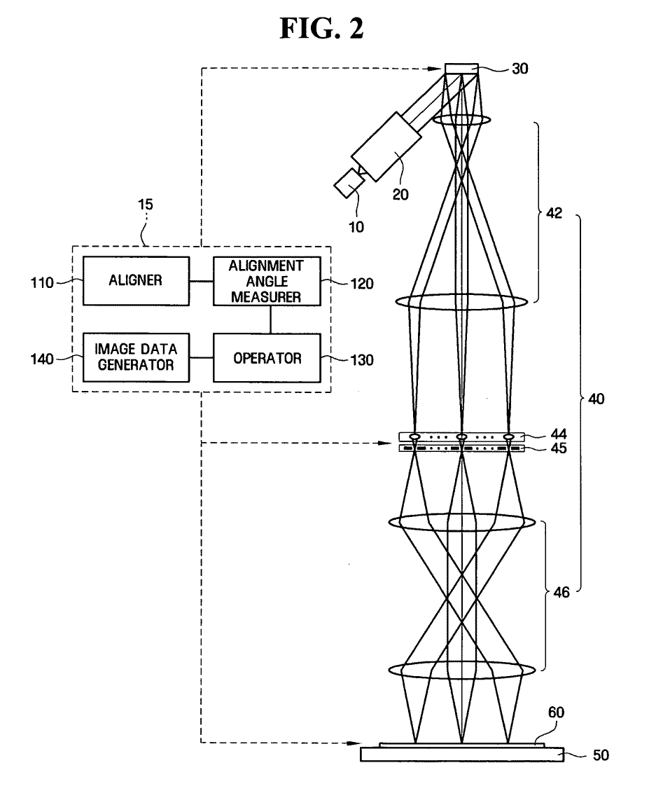

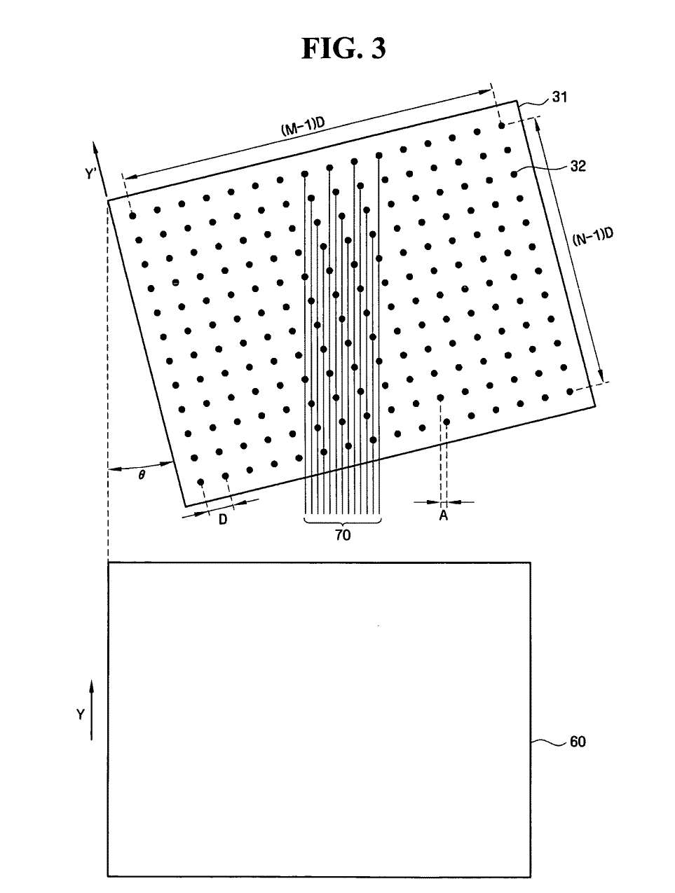

Hereinafter, the structure of a maskless lithographic apparatus 100 according to example embodiments may be described in detail with reference to FIGS. 1 through 3. FIG. 1 is a conceptual diagram of a maskless lithographic apparatus according to example embodiments, FIG. 2 is a cross-sectional view of the maskless lithographic apparatus of FIG. 1, and FIG. 3 is a plan view of a beam spot array in the maskless lithographic apparatus of FIG. 1.

Referring to FIGS. 1 through 3, the maskless lithographic apparatus 100 according to example embodiments may include at least one exposure head and/or a stage 50 for moving a substrate 60. The exposure head may include a light source 10 providing an exposure beam 5, an optical illumination system 20 for making uniform the illumination of the exposure beam 5 emitted from the light source 10, a light modulator 30 modulating the exposure beam 5 that has passed through the optical illumination system 20 according to an exposure beam 5, and/or an exposure optical system 40 delivering the modulated exposure beam provided by the light modulator 30 onto the substrate 60 in the form of a beam spot array.

The light source 10 may be a semiconductor laser or ultraviolet (UV) lamp.

The light modulator 30 may include a spatial light modulator (SLM). Some examples of the light modulator 30 may be a Digital Micro-Mirror Device (DMD) that is a type of Micro Electro Mechanical Systems (MEMS), two-dimensional (2D) Grating Light Valve (GLV), electric optical device using PLZT (lead zirconate titantate), or Ferroelectric Liquid Crystal (FLC). For convenience of explanation, it is assumed hereinafter that the light modulator 30 is a DMD.

The DMD may include a substrate, memory cells (SRAM cells) formed on the substrate, and/or multiple micromirrors that may be arranged in a matrix on the memory cells.

For example, the DMD may include micromirrors arranged in 1024 columns and 768 rows at substantially equal pitch (e.g., about 13.7 μm) in row and column directions. A highly reflective material such as aluminum (Al) may be deposited on a surface of each micromirror. In this case, the micromirror may have a reflectivity of about 90%. The micromirror also may be supported on a memory cell by a hinge support.

Upon application of a digital signal to a memory cell in the DMD, a micromirror supported by the hinge support may be tilted within a range between degrees +α and −α (e.g., ±12 degrees) with respect to a surface of the substrate. Thus, by controlling the tilt angle of a micromirror in the DMD according to information contained in an exposure pattern, the exposure beam 5 that has entered the DMD may be reflected in a specific direction according to the tilt angle of each micromirror.

The on/off state of each micromirror in the DMD may be controlled by a control unit 15. For example, when a micromirror is tilted at degree +α, the exposure beam 5 may be reflected by the micromirror toward the exposure optical system 40, which is called the “switched-on state.” In contrast, when the micromirror is tilted at degree −α, the exposure beam 5 may be reflected by the micromirror toward a light absorber (not shown), which is called the “switched-off state”.

The exposure optical system 40 may include a first imaging optical system 42, a micro-lens array 44, an aperture array 45, and/or a second imaging optical system 46 that may be arranged along a path in which the exposure beam 5 passes.

The first imaging optical system 42 may be a double telecentric optical system that forms an image that has passed through the light modulator 30 at an aperture plane of the micro-lens array 44, i.e., by enlarging the image by a factor of 4. The second imaging optical system 46 also may be a double telecentric optical system that forms a plurality of beam spots at a focal plane of the micro-lens array 44 by a factor of about 1 on the substrate 60. While it is described in example embodiments that the first imaging optical system 42 and the second imaging optical system 46 may have magnifying powers of about 4 and 1, respectively, they are not limited thereto and may provide an optimal combination of magnifying powers according to desired beam spot size, minimum feature size of a pattern to be exposed, and/or the number of exposure heads to be used in a lithographic apparatus.

The micro-lens array 44 may be a 2D array having a plurality of micro lenses corresponding to the micromirrors in the light modulator 30. For example, if the light modulator 30 consists of 1024×768 micromirrors, the micro-lens array 44 also may have the same number of micro lenses. A pitch of a micro lens in the micro-lens array 44 may be substantially equal to a pitch of micromirrors in the light modulator 30 multiplied by the magnifying power of the first imaging optical system 42. For example, the pitch of a micro lens in the micro-lens array 44 may be about 55 μm.

The aperture array 45 may be a 2D array having a plurality of pinholes located at positions along the focal plane of the micro-lens array 44 corresponding to the micro lenses in the micro-lens array 44. The plurality of pinholes may shape a beam spot focused through the micro lenses to a specific size or may block noise generated in the optical system. For example, each pinhole may have a diameter of about 6 μm.

The exposure beam 5 may have a circular or elliptical shape as it passes through the light modulator 30 and the first imaging optical system 42 and is focused onto the focal plane of the micro-lens array 44. The exposure beam 5 then may pass through the second imaging optical system 46 to form a beam spot array 31 on the substrate 60. The beam spot array 31 may include a plurality of beam spots 32 arranged in a matrix. For example, the beam spot 32 may have a pitch of about 55 μm and/or may have a circular Gaussian distribution with a Full Width at Half Maximum (FWHM) of about 2.5 μm.

The substrate 60 may be coated with a pattern-forming material such as a photosensitive material and/or may be supported by the stage 50. A guide (not shown), extending along the direction in which the stage 50 moves, may be installed on the stage 50 and/or may allow the stage 50 to reciprocate along a scan direction Y. Although not shown in FIGS. 1 and 2, the maskless lithographic apparatus 100 may further include a separate driving device for driving the stage 50 along the guide. While in example embodiments, the stage 50 on which the substrate 60 may be seated may move with respect to the exposure head, the stage 50 may be fixed and the exposure head may be movable. Both of the stage 50 and exposure head may be movable. Further, while in example embodiments, one exposure head may be disposed above the substrate 60, a plurality of exposure heads may be arranged in a direction orthogonal to the scan direction Y of the stage 50 in order to reduce the process time.

The exposure head, including the light modulator 30 and the micro-lens array 44, may be tilted at a predetermined alignment angle θ with respect to the scan direction Y of the substrate 60. More specifically, when a direction Y′ in which the beam spot array 31 (and/or light modulator 30) is arranged, which may be dependent on the tilt angle of the exposure head, is tilted at the alignment angle θ with respect to the scan direction Y, the resolution of the maskless lithographic apparatus 100 may increase. Although in example embodiments, the entire exposure head may rotate by the alignment angle θ, only a part of the exposure head, such as the light modulator 30, the micro-lens array 44, and/or the aperture array 45, may be rotated to achieve the same or similar effect.

The control unit 15 may include an aligner 110 aligning the light modulator 30 in a specific direction with respect to the stage 50, an alignment angle measurer 120 measuring an actual alignment angle between the scan direction Y and the direction Y′ in which the beam spot array 31 (and/or light modulator 30) is arranged, an operator 130 calculating the number of rows of the light modulator 30 to be used using the actual alignment angle provided by the alignment angle measurer 120, and/or an image data generator 140 generating image data concerning the on/off state of the light modulator 30 (hereinafter referred to as the “on/off image data”) from the number of rows available.

While in example embodiments, the control unit 15 may reset the on/off image data in order to achieve a uniform exposure energy distribution, the on/off state of the micro-lens array 44 may be reset to achieve the same result.

Referring to FIG. 3, the light modulator 30 may modulate the incident exposure beam 5 to produce the beam spot array 31 having the plurality of beam spots 32 above the substrate 60. The plurality of beam spots 32 in the beam spot array 31 may correspond to the micromirrors in the light modulator 30 and/or the micro lenses in the micro-lens array 44. Thus, the light modulator 30, the micro-lens array 44, and/or the beam spot array 31 may be arranged in substantially the same direction (Y′). If the light modulator 30 consists of M (columns)×N (rows) of micromirrors in example embodiments, the beam spot array 31 also may have M×N micro lenses. In this case, the plurality of beam spots 32 may be arranged at substantially equal pitch D in row and/or column directions.

The aligner 110 may rotate the stage 50 and/or the exposure head so that the arrangement direction Y′ of the beam spot array 31 (and/or light modulator 30) forms the alignment angle θ with the scan direction Y of the substrate 60. As a result, a scan line 70 may be formed along a region in which the plurality of beam spots 32 are produced onto the substrate 60 while the substrate 60 may move long the scan direction Y. Thus, if the scan direction Y forms the alignment angle θ with the arrangement direction Y′, a distance A between adjacent scan lines 70 may decrease while the pitch D between the beam spots 32 may be kept constant. Thus, the resolution of the maskless lithographic apparatus 100 may be increased.

The distance A between the adjacent scan lines 70 may satisfy the Equation (1) with respect to the pitch D of the beam spot 32.

A=D×sin θ (1)

If the alignment angle is 0°, for example, the plurality of beam spots 32 may be arranged on a single scan line 70. The number of beam spots 32 arranged on the scan line 70 is called iteration number K.

The alignment angle θ, the number N of rows of the light modulator 30, and the iteration number K may be defined by Equations (2) and (3):

$$\begin{matrix}{sin}^{2} θ = \frac{{K}^{2}}{{K}^{2} + {N}^{2}} \\ θ = {sin}^{- 1} \sqrt{\frac{{K}^{2}}{{K}^{2} + {N}^{2}}} & ( 2 ) \\ K = N \times tan θ \\ N = \frac{K}{tan θ} & ( 3 )\end{matrix}$$

To make uniform spatial exposure energy distribution in a beam spot array-type lithographic apparatus, the exposure head may need to be tilted at the alignment angle θ at which the iteration number K is an integer.

More specifically, the alignment angle θ of the exposure head required by the number N of rows of the light modulator 30 and the iteration number K may be determined using Equation (3). If image data of the light modulator 30 corresponding to the exposure pattern is generated based on such a geometric structure, the angle of rotation of the exposure head with respect to the scan direction Y may need to exactly match the alignment angle θ in order to make exposure amounts uniform. However, even a slight alignment error, for example, 0.001°, may lead to quite uneven exposure energy distribution, which is not negligible, meaning the alignment error may have to be less than 0.001°. It is practically very difficult to rotate the exposure head for such precise alignment. A method for compensating for an alignment error according to example embodiments may achieve uniform exposure energy distribution by compensating for the on/off state of the light modulator 30 and/or the micro-lens array 44 instead of the alignment angle θ between the light modulator 30 and the stage 50.

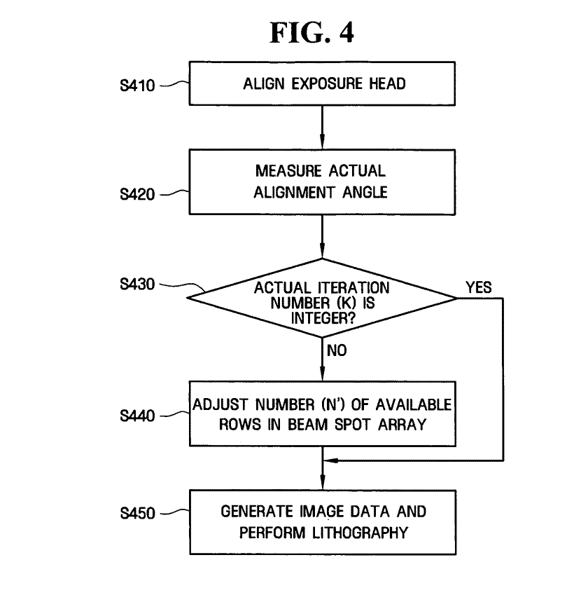

A method for compensating for an alignment error using the maskless lithographic apparatus 100 is described in detail with reference to FIGS. 1 through 4. FIG. 4 is a flowchart illustrating a method of compensating for an alignment error in a maskless lithographic apparatus according to example embodiments.

Referring to FIGS. 1 through 4, the aligner 110 may align the exposure head with respect to the stage 50 at an ideal alignment angle θ1 (S410). In this case, the ideal alignment angle θ1 may refer to an angle between the scan direction Y of the stage 50 and the direction Y′ desired by a user in which the micromirrors in the light modulator 30 are arranged, without regard to an alignment error.

The alignment angle measurer 120 may measure the position of the beam spot 32 and then an actual alignment angle θ2 between the arrangement direction Y′ of the beam spot array 31 (and/or light modulator 30) and the scan direction Y (S420). The difference between the ideal alignment angle θ1 and actual alignment angle θ2 may represent an alignment error.

The operator 130 may substitute the actual alignment angle θ2 and the number N of rows in the light modulator 30 into the Equation (3). The operator 130 also may determine whether the actual iteration number K is an integer for a subsequent operation (S430).

If the actual iteration number K is an integer in step S430, exposure energy distribution may be uniform across the entire exposure pattern. Thus, the image data generator 140 may generate image data concerning the light modulator 30 based on information about the position of the beam spot array 31 without a separate compensation process and performs a lithography process (S450).

If the actual iteration number K is not an integer in step S430, the amount of exposure energy may vary between specific scan lines 70. That is, the number of beam spots overlapping the scan lines 70 may vary from scan line to scan line, thereby resulting in non-uniform exposure energy distribution. To reduce the amount of exposure energy for the specific scan line 70 which excessive number of beam spots 32 overlap, some of the beam spots 32 overlapping the scan line 70 may be switched off. By adjusting the number N′ of rows in the beam spot array 31 to be actually used, i.e., by switching some of the rows in the beam spot array 31 to an off state, the exposure energy distribution can be made uniform (S440).

In this case, switching off some of the rows in the beam spot array 31 may be achieved by generating on/off image data in which some of the rows of micromirrors in the light modulator 30 are switched off, and/or switching off some of the rows of micro lenses in the micro-lens array 44. In order to switch off some of the rows of micro lenses, a separate means may be required to prevent the exposure beam 5 from passing through the rows of the micro lenses or apertures.

If the actual iteration number K is not an integer, an integerized iteration number m that is less than the actual iteration number K may be defined. In order to obtain uniform exposure energy distribution, the operator 130 may substitute the integerized iteration number m and the actual alignment angle θ2 into Equation (4) below to obtain the number N′ of rows in the beam spot array 31 to be used. If the integerized iteration number m is closest to the actual iteration number K, the following inequality is satisfied: m<K<m+1. In this case, an angular range corresponding to this range may be designated as an alignment angle tolerance of the exposure head.

$${N}^{′} = round ( \frac{m}{tan θ 2} ) \\ ( Round denotes a rounding function . ) \qquad ( 4 )$$

The image data generator 140 may switch off some of the rows in the beam spot array 31 based on the number N′ of available rows of the beam spot array 31. More specifically, the image data generator 140 may generate on/off image data in which some of the rows of micromirrors in the light modulator 30 are switched off, and/or may switch off some of the rows of micro lenses in the micro-lens array 44. The number of the rows that are switched off may be N-N′. That is, a number N-N′ of rows of the light modulator 30 or the micro-lens array 44 may be switched off.

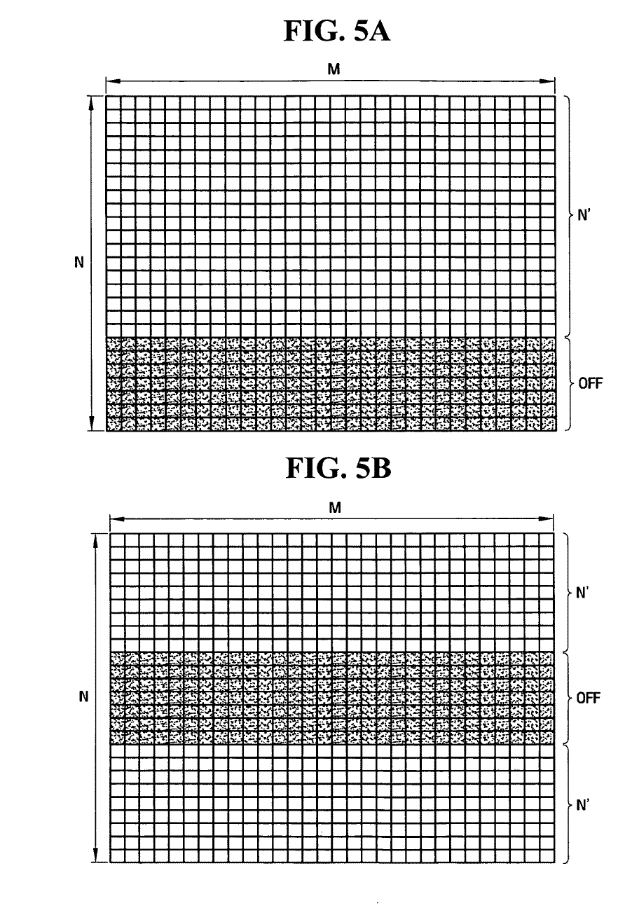

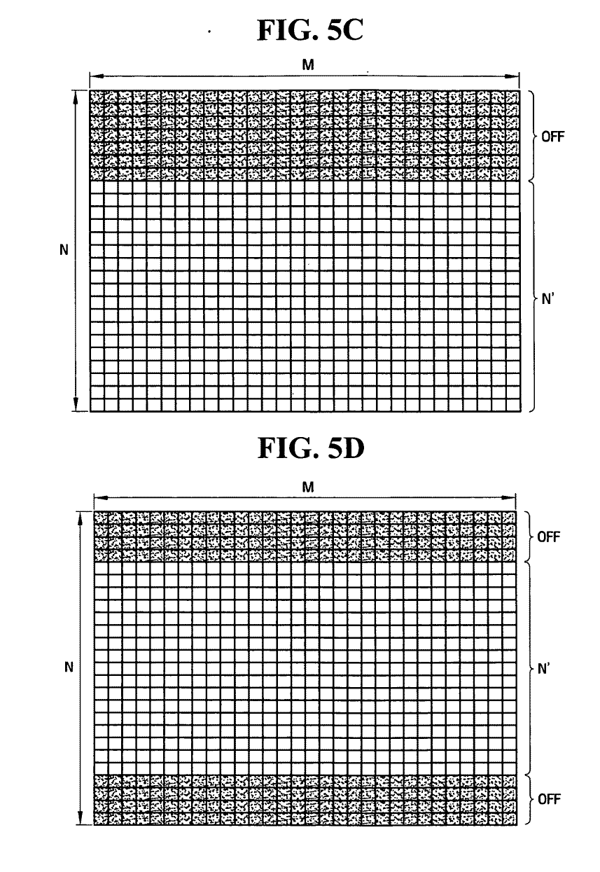

FIGS. 5A through 5D illustrate examples of the positions of rows in the light modulator 30 or the micro-lens array 44 that may be switched off. FIGS. 5A through 5D are plan views illustrating rows of micromirrors in a light modulator and/or micro lenses in a micro-lens array that are switched off according to example embodiments.

As shown in FIGS. 5A through 5C, rows OFF that are switched off may be located at the end, middle, and/or start of the entire array, respectively. As shown in FIG. 5D, some of the rows OFF also may be located at the start thereof while the remaining rows OFF may be at the end thereof. Although not shown in FIGS. 5A through 5D, the switched-off rows OFF may be divided into several segments and positioned at different locations, similar to the way shown in FIG. 5D.

Returning to FIG. 4, after generating image data for switching off some of the rows of the beam spot array 31, a lithography process may be performed using the remaining rows of the beam spot array 31 (S450).

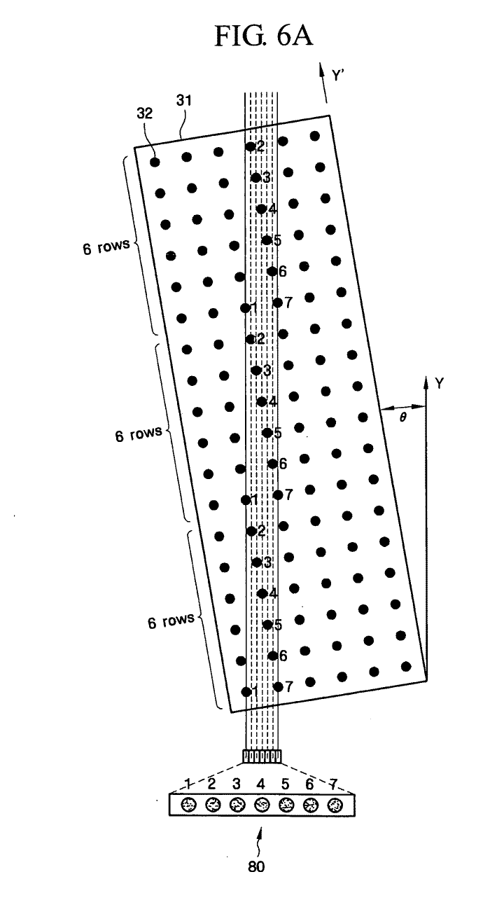

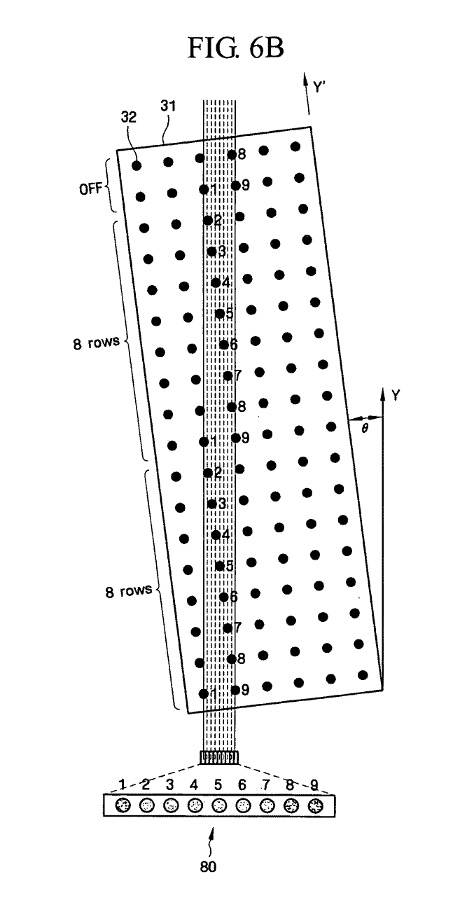

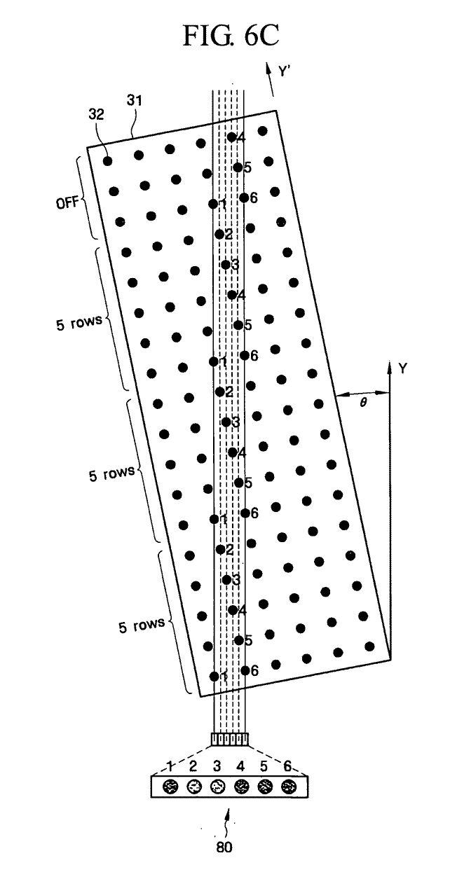

A method for compensating for an alignment error using a maskless lithographic apparatus according to example embodiments is described in detail with reference to FIGS. 6A through 6C. FIGS. 6A through 6C are plan views illustrating distribution of exposure energy that may vary with an alignment error in a maskless lithographic apparatus according to example embodiments.

In example embodiments, the beam spot array 31 may include 6 (columns)×18 (rows) beam spots 32. A default iteration number K may be set to 3 and/or the beam spot array 31 may be aligned with respect to the scan direction Y. If the beam spot array 31 is ideally aligned, an ideal alignment angle θ1 between the scan direction Y and arrangement direction Y′ of the beam spot array 31 (and/or light modulator 30) may be 9.462°. For convenience of explanation, it is assumed hereinafter that 18 rows of the beam spot array 31 are numbered from bottom to top starting with 1.

FIG. 6A illustrates a case in which the beam spot array 31 may be precisely aligned with the scan direction Y without an alignment error so that the actual iteration number K is 3. Referring to FIG. 6A, the actual alignment angle θ2 is equal to the ideal alignment angle θ1 (θ2=θ1=9.462°). Six scan lines 1 through 6 may be arranged between the horizontally neighboring beam spots 32. Since three beam spots 32 overlap each of the scan lines 1 through 6, exposure energy distribution in each scan line may be uniform and even as shown in an exposure energy distribution diagram 80.

FIG. 6B illustrates a case in which the beam spot array 31 and the scan direction Y may be aligned with an alignment error. The actual alignment angle θ2 between the arrangement direction Y′ of the beam spot array 31 (and/or light modulator 30) and the scan direction Y may be 7.125°. The number N of the rows in the beam spot array 31 and the actual alignment angle θ2 may be substituted into the Equation (3) to determine the actual iteration number K of 2.25. Referring to FIG. 6B, eight scan lines 1 through 8 may be arranged between the horizontally neighboring beam spots 32. While three beam spots 32 overlap the scan lines 1 and 8, two beam spots 32 overlap the remaining scan lines. Thus, as shown in an exposure energy distribution diagram 80, exposure energy distribution in each scan line may be uneven. When two of the rows in the beam spot array 31 are switched OFF, two beam spots 32 may overlap each of the scan lines 1 through 8. That is, exposure energy distribution may become uniform (or more uniform).

Since the integerized iteration number m is an integer less than the actual iteration number K, m=2. The iteration number m and the actual alignment angle θ2 may be substituted into Equation (4) to obtain the number N′ (=16) of available rows in the beam spot array 31.

While rows 17 and 18 are the rows OFF in the beam spot array 31 that are switched off, feasible combinations of the rows OFF may include (row 1, row 2), (row 9, row 10), (row 1, row 10), (row 1, row 18), (row 2, row 9), (row 2, row 17), (row 9, row 18), and (row 10, row 17).

FIG. 6C illustrates a case in which the beam spot array 31 and the scan direction Y may be aligned with an alignment error. The actual alignment angle θ2 between the arrangement direction Y′ of the beam spot array 31 and the scan direction Y may be 11.310°. The number N of the rows in the beam spot array 31 and the actual alignment angle θ2 may be substituted into the Equation (3) to determine the actual iteration number K of 3.60. Referring to FIG. 6C, five scan lines 1 through 5 may be arranged between the horizontally neighboring beam spots 32. While four beam spots 32 overlap the scan lines 1, 4 and 5, three beam spots 32 overlap the remaining scan lines. Thus, as shown in an exposure energy distribution diagram 80, exposure energy distribution in each scan line may be non-uniform. When three of the rows in the beam spot array 31 are switched off, three beam spots 32 may overlap each of the scan lines 1 through 5. That is, exposure energy distribution may become uniform (or more uniform).

Since the integerized iteration number m is an integer less than the actual iteration number K, m=3. The iteration number m and the actual alignment angle θ2 may be substituted into Equation (4) to obtain the number N′ (=15) of available rows in the beam spot array 31.

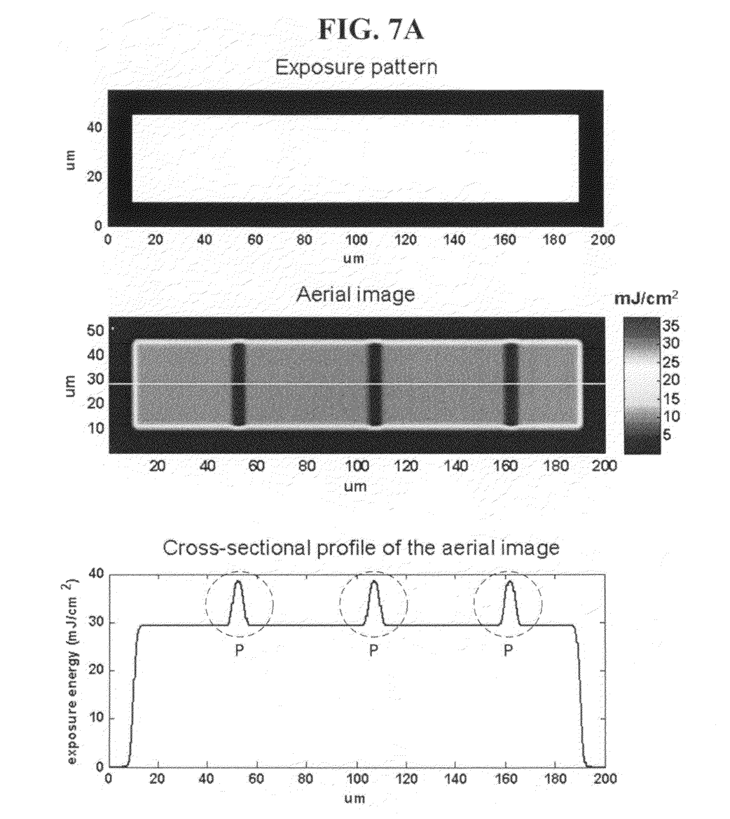

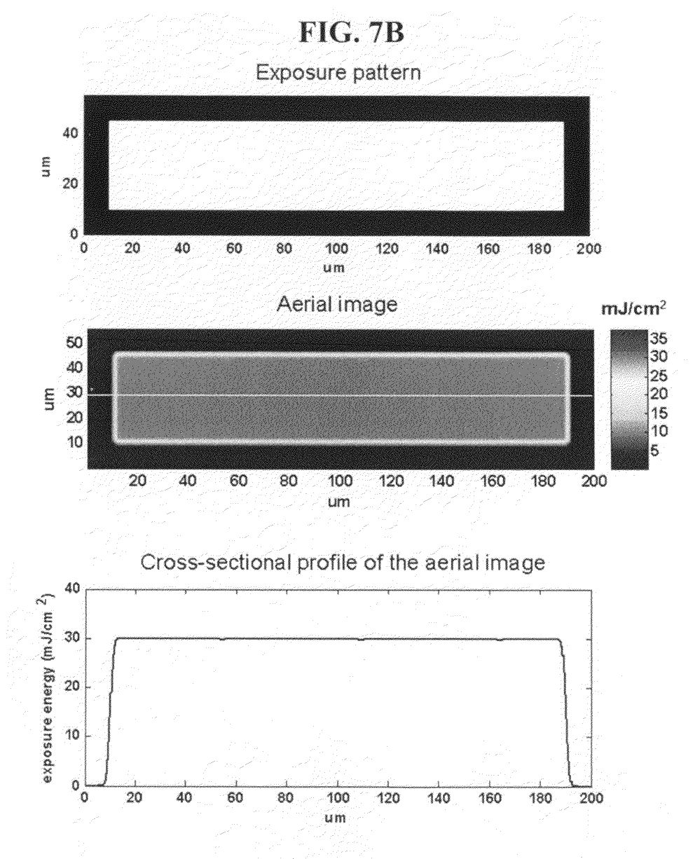

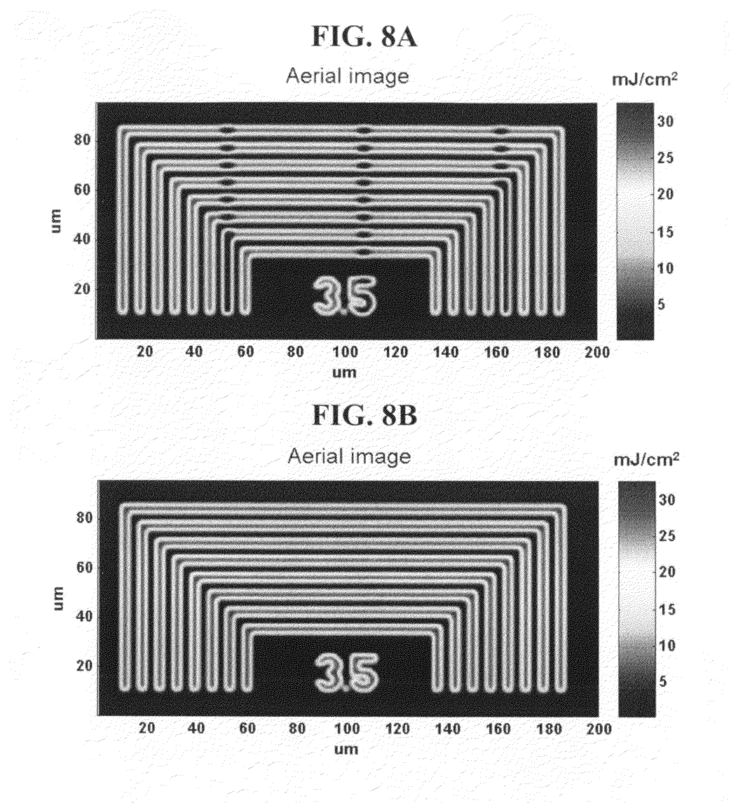

FIGS. 7A through 8B illustrate the results of exposure simulation showing uniformity of exposure amount before and after compensating for an alignment error. FIG. 7A illustrates exposure energy distribution and aerial images produced without compensation for an alignment error, FIG. 7B illustrates exposure energy distribution and aerial images produced with compensation for an alignment error, FIG. 8A illustrates an aerial image of an exposure pattern produced without compensation for an alignment error, and FIG. 8B illustrates an aerial image of an exposure pattern produced with compensation for an alignment error.

In the simulation, the light modulator 30 having 1024 columns and 768 rows was used. The exposure head or the stage 50 rotated so that the iteration number K was 3. The ideal alignment angle θ1 was 0.22381°. However, since it is practically impossible to align at the ideal alignment angle θ due to limitations of an alignment system, an alignment tolerance was set to an angular range between 0.22381° and 0.29841° corresponding to 3≦iteration number K<4. As a result of measurement, the actual alignment angle θ2 was assumed to be 0.230°. In this case, the actual iteration number K was 3.083. It was also assumed that the switching speed of the light modulator 30 was 10 kHz and the scan rate of the stage 50 was 10 mm/s. FIGS. 7A and 8A illustrate data obtained by lithography using all the rows (768 rows) in the beam spot array 31. FIGS. 7B and 8B illustrate data obtained by lithography using some of the 768 rows (747 rows) in the beam spot array 31.

Assuming that the integerized iteration number m is 3 for compensation of an alignment error, the actual alignment angle θ2 and the iteration number m may be substituted into Equation (4) above to determine the number N′ (=747) of available rows in the beam spot array 31. Thus, the number of rows OFF that are switched off may be 21.

Referring to FIG. 7A, before compensation of an alignment error, the amount of exposure energy rapidly may increase at specific portions P with a period of about 55 μm, that is the distance between horizontally neighboring beam spots 32. Thus, FIG. 7A shows non-uniform distribution of exposure energy across the entire aerial image. Conversely, referring to FIG. 7B, an aerial image with non-uniformity of less than 1% may be obtained after compensating for an alignment error.

Similarly, referring to FIG. 8A, an excessive amount of exposure energy may be periodically observed in some lines on a pattern image. FIG. 8B shows uniform exposure energy distribution across the entire aerial image.

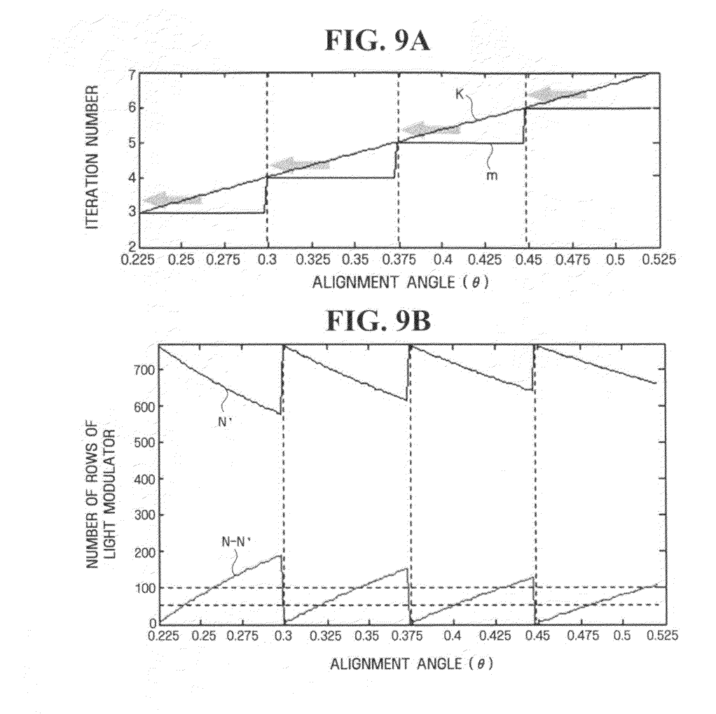

An alignment error tolerance with respect to iteration number is described in detail with reference to FIGS. 9A and 9B. FIG. 9A is a graph of an actual iteration number K and an integerized iteration number m against an alignment angle, and FIG. 9B is a graph of the number N′ of rows of a light modulator against an alignment angle (θ) when an alignment error is compensated for. It is assumed herein that a light modulator having 1024 columns and 768 rows was used.

Referring to FIGS. 9A and 9B, when the integerized iteration number m is 3, 4, 5, and 6, tolerance range of an alignment angle θ may be 0.224° to 0.298°, 0.298° to 0.373°, 0.373° to 0.448°, and 0.448° to 0.522°, respectively. The difference between the upper and lower limits in the range may be about 0.075°. The number N′ of available rows with respect to each integerized iteration number m is 573 to 768.

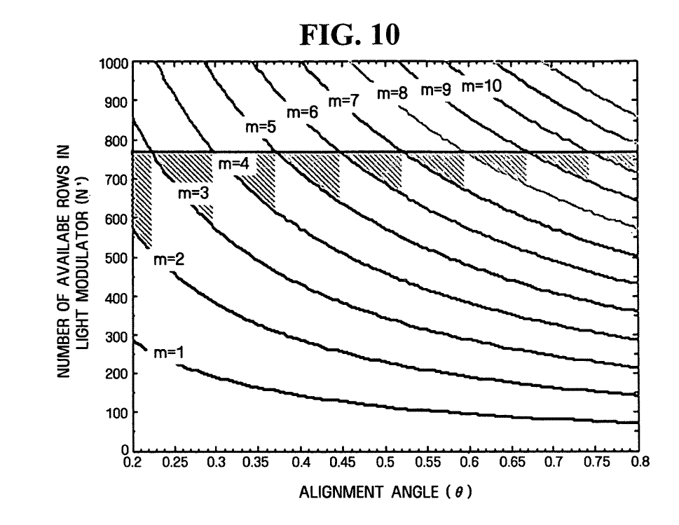

In the above-mentioned embodiments, if the actual iteration number K is not an integer, the number N′ of available rows in the beam spot array 31 may be calculated using the integerized iteration number m closest thereto. However, any integerized iteration number m less than the actual iteration number K may be selected for calculation, which will be described in detail below with reference to FIG. 10. It is assumed herein that a light modulator having 1024 columns and 768 rows was used.

Referring to FIG. 10, if the alignment angle θ is 0.50°, the number N′ of available rows may be adjusted to 115, 229, 344, 458, 573, and 688, to then obtain the integerized iteration number m of 1, 2, 3, 4, 5, and 6. If there is a large difference between the integerized iteration number m and the actual iteration number K, the power of the exposure beam 5 provided by the light source 10 may be increased to obtain the same exposure amount.

While example embodiments have been particularly shown and described, it will be understood by those of ordinary skill in the art that various changes in form and details may be made therein without departing from the spirit and scope of the present invention as defined by the following claims.

What is claimed is:

1. A maskless lithographic apparatus, comprising:
a light source providing an exposure beam;
a light modulator modulating the exposure beam according to an exposure pattern;
an exposure optical system delivering the modulated exposure beam provided by the light modulator onto a substrate in a form of a beam spot array; and
a control unit switching off some rows in the beam spot array in order to make exposure energy distribution uniform across the beam spot array.

2. The apparatus of claim 1, wherein a scan direction of the substrate is tilted at an alignment angle with respect to a direction in which the light modulator is arranged.

3. The apparatus of claim 1, wherein the control unit switches off some rows in the light modulator.

4. The apparatus of claim 1, wherein the exposure optical system includes a micro-lens array condensing the beam spot array in order to increase a resolution, and
wherein the control unit switches off some rows in the micro-lens array.

5. The apparatus of claim 1, wherein the control unit comprises:
an aligner arranging the light modulator in a direction that is tilted at an initial alignment angle with respect to a scan direction of the substrate;
an alignment angle measurer measuring an actual alignment angle between the scan direction and the arrangement direction;
an operator calculating the number of rows in the beam spot array to be used using the actual alignment angle; and
an image data generator resetting on/off state of the light modulator or the exposure optical system using the number of rows to be used.

6. The apparatus of claim 5, wherein when a scan line is formed along a region in which beam spots of the beam spot array are produced onto the substrate while the substrate moves along the scan direction and an iteration number K denotes the number of the beam spots arranged on each scan line, then the control unit switches off some of the rows in the beam spot array in order to make the iteration number K in each scan line uniform.

7. The apparatus of claim 6, wherein when the light modulator has M columns and N rows, an integerized iteration number less than the iteration number K is m, round denotes a rounding function, and an actual alignment angle is θ2, then the number N′ of rows in the light modulator to be used satisfies the following equation:
$${N}^{′} = round ( \frac{m}{tan θ 2} ) .$$

8. The apparatus of claim 1, wherein the light modulator is a Digital Micro-Mirror Device (DMD).

9. The apparatus of claim 1, wherein rows in the beam spot array that are switched off are located at either or both of a start and end of the beam spot array.

10. A method for compensating for alignment error using a maskless lithographic apparatus, the method comprising:
providing an exposure beam;
modulating the exposure beam according to an exposure pattern;
delivering the modulated exposure beam provided by a light modulator onto a substrate in a form of a beam spot array; and
switching off some rows in the beam spot array in order to make exposure energy distribution uniform across the beam spot array.

11. The method of claim 10, further comprising:
tilting a scan direction of the substrate at an alignment angle with respect to a direction in which the light modulator is arranged.

12. The method of claim 10, wherein delivering of the modulated exposure beam comprises condensing the beam spot array using a micro-lens array.

13. The method of claim 10, wherein switching off some rows comprises arranging the light modulator in a direction that is tilted at an initial alignment angle with respect to a scan direction of the substrate, measuring an actual alignment angle between the scan direction and the arrangement direction, calculating a number of rows in the beam spot array to be used using the actual alignment angle, and switching off some of the rows in the beam spot array using a number of rows available.

14. The method of claim 13, wherein when a scan line is formed along a region in which beam spots of the beam spot array are produced onto the substrate while the substrate moves along the scan direction, and an iteration number K denotes a number of the beam spots arranged on each scan line, then a control unit switches off some of the rows in the beam spot array in order to make the iteration number K in each scan line uniform.

15. The method of claim 14, wherein when the light modulator has M columns and N rows, an integerized iteration number less than the iteration number K is m and round denotes a round function, and an actual alignment angle is θ2, the number N′ of rows in the light modulator to be used satisfies the following Equation:
$${N}^{′} = round ( \frac{m}{tan θ 2} ) .$$

16. The method of claim 10, wherein modulating the exposure beam is performed using a Digital Micro-Mirror Device (DMD).

17. The method of claim 10, wherein switching off some rows comprises switching off the rows that are located at either or both of a start and end of the beam spot array.
